(19) United States
(12) Patent Application Publication
(10) Pub. No.: US 2026/0303539 A1
(43) Pub. Date: Oct. 1, 2026

(54) PSI BASED DISCARD

(71) Applicant: LENOVO (BEIJING) LIMITED, Beijing (CN)

(72) Inventors: Xiaoying XU, Beijing (CN); Mingzeng DAI, Beijing (CN); Lianhai WU, Beijing (CN)

(21) Appl. No.: 19/480,602

(22) PCT Filed: Nov. 3, 2023
(86) PCT No.: PCT/CN2023/129653

§ 371 Date: Oct. 31, 2025

(51) Int. Cl. H04L 47/32; H04W 28/02; H04W 28/06

(52) U.S. Cl. CPC H04L 47/32; H04W 28/0268; H04W 28/06

(57) ABSTRACT

Various aspects of the present disclosure relate to PSI based discard. In one aspect, a UE receive an indication from a base station. The indication indicates whether to activate PSI based discard for a DRB. In turn, the UE determines, based at least on the indication, whether to start a discard timer for data belonging to low importance data on the DRB. The discard timer is associated with the PSI based discard.

### TECHNICAL FIELD

The present disclosure relates to wireless communications, and more specifically to user equipment (UE), network nodes and methods for supporting Protocol Data Unit Set Importance (PSI) based discard.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Extended Reality (XR), including Augmented Reality (AR) and Virtual Reality (VR), as well as Cloud Gaming (CG), presents a new promising category of connected devices, applications, and services.

A concept of a Protocol Data Unit (PDU) Set is introduced for XR services. A PDU Set may comprise one or more PDUs carrying a payload of one unit of information generated at an application level. For example, the unit of information may be a frame or video slice for XR services. In some implementations, all PDUs in a PDU Set are needed by an application layer to use the corresponding unit of information. In other implementations, the application layer can still recover part or all of the information unit when some PDUs in the PDU Set are missing.

PDU Sets may carry different contents with different importance levels. A PSI value or PSI level may identify the relative importance of a PDU Set compared to other PDU Sets within a QoS Flow. A PDU Set with high importance may still be needed in the decoding of subsequent PDU Sets, even after it misses its own decoding deadline (PSDB).

An additional Packet Data Convergence Protocol (PDCP) discard timer for low or lower importance PDU Sets may be used for a PDCP entity of a Data Radio Bearer (DRB) in uplink (UL) if a base station activates PSI-based discard in case of congestion detected in UL. There is a need to study how to apply the additional PDCP discard timer for lower importance PDU Sets to which DRBs.

### SUMMARY

The present disclosure relates to UE, network nodes and methods that support PSI based discard. With the UE, network nodes and methods, PSI based discard may be achieved.

Some implementations of a UE described herein may include a processor and a transceiver coupled to the processor, wherein the processor is configured to: receive an indication via the transceiver from a network entity, the indication indicating whether to activate PSI based discard for a DRB; and determine, based at least on the indication, whether to start a discard timer for data belonging to low importance data (e.g., with a PSI value) on the DRB, the discard timer being associated with the PSI based discard.

In some implementations, the processor is configured to receive the indication via a first Medium Access Control (MAC) entity of the UE.

In some implementations, the processor is configured to determine whether to start the discard timer based on determining that at least one Radio Link Control (RLC) entity of the DRB is associated with the first MAC entity.

In some implementations, the at least one RLC entity of the DRB comprises all RLC entities of the DRB; or the at least one RLC entity of the DRB comprises a primary RLC entity of the DRB.

In some implementations, the processor is configured to determine whether to start the discard timer further based on determining that packet data convergence protocol (PDCP) duplication is activated for the DRB.

In some implementations, the PDCP duplication is activated for the DRB; and the at least one RLC entity of the DRB comprises all activated duplication RLC entities and the primary RLC entity of the DRB; or the at least one RLC entity of the DRB comprises an activated duplication RLC entity of the DRB; or the at least one RLC entity of the DRB comprises a primary RLC entity of a duplication DRB.

In some implementations, the indication further indicates whether to activate the PSI based discard for at least one cell group. In such implementations, the processor is configured to determine whether to start the discard timer based on determining that the DRB is associated with one of the at least one cell group.

In some implementations, the indication further indicates whether to activate the PSI based discard for at least one cell group. In such implementations, the processor is configured to determine whether to start the discard timer based on determining that at least one RLC entity of the DRB is associated with one of the at least one cell group.

In some implementations, the processor is configured to determine whether to start the discard timer further based on determining that packet data convergence protocol (PDCP) duplication is activated for the DRB.

In some implementations, the at least one RLC entity of the DRB comprises all RLC entities of the DRB.

In some implementations, the at least one RLC entity of the DRB comprises a primary RLC entity of the DRB.

In some implementations, the indication further indicates whether to activate the PSI based discard for at least one bearer type. In such implementations, the processor is configured to determine whether to start the discard timer based on determining that the DRB is of one of the at least one bearer type.

Some implementations of a first network node described herein may include a processor and a transceiver coupled to the processor, wherein the processor is configured to: transmit, via the transceiver to a second network node, first information about a configuration of PSI based discard for a DRB; and transmit the configuration of PSI based discard via the transceiver to a UE.

In some implementations, the processor is further configured to: receive, via the transceiver from a third network node, second information about activation or deactivation of the PSI based discard; and transmit, via the transceiver to the second network node, the second information about activation or deactivation of the PSI based discard.

In some implementations, the second information about activation or deactivation of the PSI based discard comprises one of the following: contents in a MAC CE carrying an indication indicating whether to activate the PSI based discard, a request for transmitting the indication indicating whether to activate the PSI based discard to the UE, or an uplink congestion status in the third network node.

In some implementations, the indication further indicates whether to activate the PSI based discard for at least one cell group; or the indication further indicates whether to activate the PSI based discard for at least one bearer type.

Some implementations of a second network node described herein may include a processor and a transceiver coupled to the processor, wherein the processor is configured to: receive, via the transceiver from a first network node, first information about a configuration of PSI based discard for a DRB; and transmit, via the transceiver to a UE, an indication indicating whether to activate the PSI based discard.

In some implementations, the processor is further configured to: receive, via the transceiver from the first network node, second information about activation or deactivation of the PSI based discard; and the processor is configured to transmit the indication based on the second information.

In some implementations, the second information about activation or deactivation of the PSI based discard comprises one of the following: contents in a MAC CE carrying an indication indicating whether to activate the PSI based discard, a request for transmitting the indication indicating whether to activate the PSI based discard from the first network node to the UE, or an uplink congestion status in the second network node.

In some implementations, the indication further indicates whether to activate the PSI based discard for at least one cell group; or the indication further indicates whether to activate the PSI based discard for at least one bearer type.

Some implementations of a method described herein may include: receiving an indication from a network entity, the indication indicating whether to activate PSI based discard for a DRB; and determining, based at least on the indication, whether to start a discard timer for data belonging to low importance data (e.g., with a PSI value) on the DRB, the discard timer being associated with the PSI based discard.

Some implementations of a method described herein may include: transmitting, to a second network node, first information about a configuration of PSI based discard for a DRB; and transmitting the configuration of PSI based discard to a UE.

Some implementations of a method described herein may include: receiving, from a first network node, first information about a configuration of PSI based discard for a DRB; and transmitting, to a UE, an indication indicating whether to activate the PSI based discard.

Some implementations of a processor described herein may include at least one memory and a controller coupled with the at least one memory and configured to cause the controller to: receive an indication from a network entity, the indication indicating whether to activate PSI based discard for a DRB; and determine, based at least on the indication, whether to start a discard timer for data belonging to low importance data (e.g., with a PSI value) on the DRB, the discard timer being associated with the PSI based discard.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1 illustrates an example of a wireless communications system that supports PSI based discard in accordance with aspects of the present disclosure;

FIG. 2 illustrates another example of a wireless communications system that supports PSI based discard in accordance with aspects of the present disclosure;

FIG. 3 illustrates an example of a radio protocol architecture for MCG, SCG and split bearers from a perspective of the UE in NR-DC with 5GC in accordance with aspects of the present disclosure;

FIG. 4 illustrates an example of packet duplication in accordance with aspects of the present disclosure;

FIG. 5 illustrates a signaling diagram illustrating an example process that supports PSI based discard in accordance with aspects of the present disclosure;

FIG. 6 illustrates a signaling diagram illustrating another example process that supports PSI based discard in accordance with aspects of the present disclosure;

FIG. 7 illustrates an example of a device that supports PSI based discard in accordance with some aspects of the present disclosure;

FIG. 8 illustrates an example of a processor that supports PSI based discard in accordance with aspects of the present disclosure; and

FIGS. 9, 10 and 11 illustrate a flowchart of a method that supports PSI based discard in accordance with aspects of the present disclosure, respectively.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As described above, an additional PDCP discard timer for low or lower importance PDU Sets may be used for a PDCP entity of a DRB in UL if a base station signals an activation/deactivation indication of the PSI-based discard in case of congestion detected in UL. The activation/deactivation indication of the PSI-based discard is signaled using an ON/OFF mechanism on a per UE basis. In other words, if the UE receives the activation indication of the PSI-based discard from any of Master Cell Group (MCG) and Secondary Cell Group (SCG), the UE will apply the additional PDCP discard timer for the low or lower importance PDU Set on all the DRBs in MCG and SCG configured with the additional PDCP discard timer. This will impact XR capacity in the MCG. Thus, there is a need to study how to apply the additional PDCP discard timer for low or lower importance PDU Sets to which DRBs.

In view of the above, the present disclosure provides a solution that supports PSI based discard. In this solution, a UE receive an indication from a base station. The indication indicates whether to activate PSI based discard for a DRB. In turn, the UE determines whether to start, based at least on the indication, a discard timer for data belonging to low importance data (e.g., with a PSI value) on the DRB. The discard timer is associated with the PSI based discard. With this solution, PSI based discard may be achieved.

Aspects of the present disclosure are described in the context of a wireless communications system.

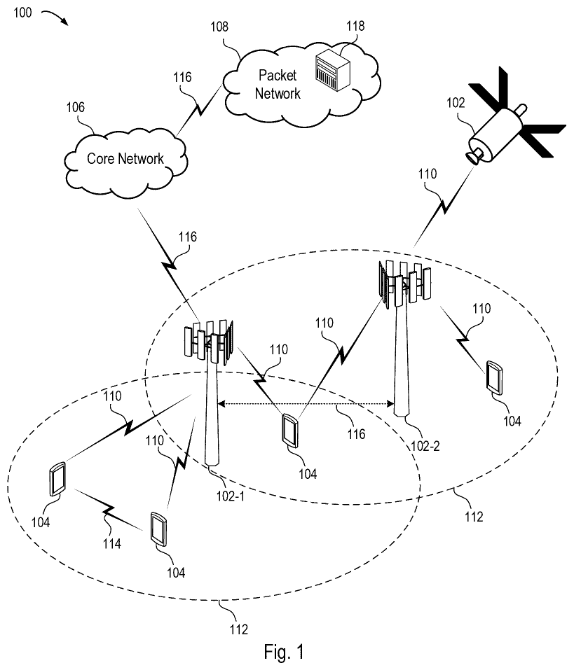

FIG. 1 illustrates an example of a wireless communications system 100 that supports PSI based discard in accordance with aspects of the present disclosure. The wireless communications system 100 may include one at least one of network entities 102 (also referred to as network equipment (NE)), one or more terminal devices or UEs 104, a core network 106, and a packet data network 108. The wireless communications system 100 may support various radio access technologies. In some implementations, the wireless communications system 100 may be a 4G network, such as an LTE network or an LTE-advanced (LTE-A) network. In some other implementations, the wireless communications system 100 may be a 5G network, such as an NR network. In other implementations, the wireless communications system 100 may be a combination of a 4G network and a 5G network, or other suitable radio access technology including institute of electrical and electronics engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The network entities 102 may be dispersed throughout a geographic region to form the wireless communications system 100. One or more of the network entities 102 described herein may be or include or may be referred to as a network node, a base station (BS), a network element, a radio access network (RAN) node, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface. The network entities 102 may be collectively referred to as network entities 102 or individually referred to as a network entity 102. Hereinafter, some implementations of the present disclosure will be described by taking a gNB as an example of the network entity 102. Thus, the network entity 102 may be used interchangeably with the gNB 102. For example, the gNBs 102 may comprise a gNB 102-1 and a gNB 102-2, as shown in FIG. 1.

In some implementations, the gNB 102 may support dual connectivity (DC) operation. For example, the gNB 102-1 may act as a master RAN node and the gNB 102-2 may act as a secondary RAN node. Hereinafter, for brevity, a master RAN node is also referred to as a master node (MN) and a secondary RAN node is also referred to as a secondary node (SN).

In some implementations, MCG may be a group of serving cells associated with the Master RAN Node, comprising a Special Cell (SpCell) which is known as a Primary Cell (PCell) and optionally one or more Secondary Cells (SCells).

In some implementations, for a UE 104 configured with dual connectivity, SCG may be a subset of serving cells comprising a Primary Secondary Cell (PSCell) and zero or more SCells.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open radio access network (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN intelligent controller (RIC) (e.g., a near-real time RIC (Near-RT RIC), a non-real time RIC (Non-RT RIC)), a service management and orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), packet data convergence protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (510 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

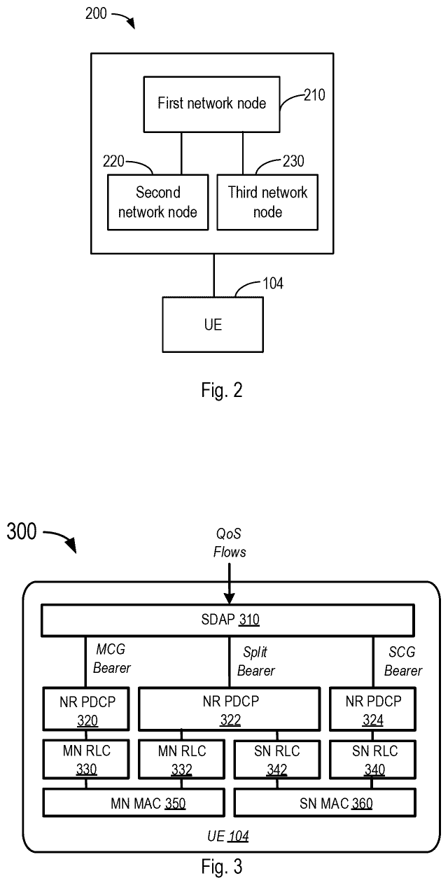

FIG. 2 illustrates another example of a wireless communications system 200 that supports PSI based discard in accordance with aspects of the present disclosure.

As shown in FIG. 2, the network entity 102 may comprise a first network node 210, a second network node 220, a third network node 230 and the UE 104.

FIG. 2 illustrates an example of a disaggregated architecture 200 of the network entity 102 in accordance with aspects of the present disclosure.

In some implementations, each of the first network node 210, the second network node 220, and the third network node 230 may be implemented as one of the following: a gNB, a base station, a network element, a RAN node, a base transceiver station, an access point, a NodeB, or an eNB.

In some implementations, the first network node 210 may be implemented as a node hosting NR PDCP entity, and one of the second network node 220 and the third network node 230 may be implemented as a corresponding node. For example, the node hosting NR PDCP entity may be an MN and the corresponding node may be an SN. Alternatively, the node hosting NR PDCP entity may be an SN and the corresponding node may be an MN. Alternatively, the node hosting NR PDCP entity may be an MN having PDCP and SDAP of a DRB, and the corresponding node may be SN having RLC and MAC of the DRB. Alternatively, the node hosting NR PDCP entity may be an SN having PDCP and SDAP of a DRB, and the corresponding node may be MN having RLC and MAC of the DRB. In some implementation, the NR PDCP entity may be other PDCP entity, e.g., LTE PDCP entity. In some implementation, a DRB has no SDAP entity.

Alternatively, in some implementations, the first network node 210, the second network node 220, and the third network node 230 may be collectively implemented as a gNB. For example, the first network node 210 may be implemented as a gNB-CU, and each of the second network node 220 and the third network node 230 may be implemented as a gNB-DU. The gNB-CU and the gNB-DU may be connected via F1 interface.

In some implementations, the gNB-CU may be a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU.

In some implementations, the gNB-DU may be a logical node hosting RLC, MAC and PHY layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

In some implementations, the node hosting NR PDCP entity may be a gNB-CU having PDCP and SDAP of a DRB, and the corresponding node may be a gNB-DU having RLC and MAC of the DRB.

FIG. 3 illustrates an example of a radio protocol architecture 300 for MCG, SCG and split bearers from a perspective of the UE 104 in NR-DC with 5GC in accordance with aspects of the present disclosure.

As shown in FIG. 3, the radio protocol architecture 300 may an SDAP entity 310, an NR PDCP entity 320, an NR PDCP entity 322, an NR PDCP entity 324, an MN RLC entity 330, an MN RLC entity 332, an SN RLC entity 340, an SN RLC entity 342, an MN MAC entity 350 and an SN MAC entity 360.

In some implementations, a radio bearer may comprise one of the following: an MCG bearer, an SCG bearer or a split bearer. In other words, a bearer type may be one of the following: an MCG bearer, an SCG bearer or a split bearer.

In some implementations, a radio bearer may comprise a data radio bearer (DRB). In such implementations, the DRB may comprise an MCG DRB, an SCG DRB or a split DRB. Some implementations of the present disclosure will be described by taking DRB as an example of a radio bearer.

In some implementations, from a network perspective, each bearer (MCG bearer, SCG bearer or split bearer) can be terminated either in MN or in SN.

In some implementations, the MCG bearer may be defined as below: in Multi-Radio Dual Connectivity (MR-DC), a radio bearer with an RLC bearer (or two RLC bearers, in case of Carrier Aggregation (CA) packet duplication in an Evolved Universal Terrestrial Radio Access Network (E-UTRAN) cell group, or up to four RLC bearers in case of CA packet duplication in an NR cell group) only in the MCG.

In some implementations, the SCG bearer may be defined as below: in MR-DC, a radio bearer with an RLC bearer (or two RLC bearers, in case of CA packet duplication in an E-UTRAN cell group, or up to four RLC bearers in case of CA packet duplication in an NR cell group) only in the SCG.

In some implementations, the split bearer may be defined as below: in MR-DC, a radio bearer with RLC bearers both in MCG and SCG. The PDCP entity is associated with two RLC entities, i.e., a primary RLC entity and a secondary RLC entity (also referred to as a split secondary RLC entity).

In some implementations, the split secondary RLC entity may be defined as below: in DC, the RLC entity other than the primary RLC entity which is responsible for split bearer operation. If the PDCP entity is associated with two RLC entities, the split secondary RLC entity is the RLC entity other than the primary RLC entity. If the PDCP entity is associated with more than two RLC entities, the split secondary RLC entity is configured by upper layers. For example, in the radio protocol architecture 300, the NR PDCP entity 322 is associated with two RLC entities, i.e., the MN RLC entity 332 and the SN RLC entity 342. One of the MN RLC entity 332 and the SN RLC entity 342 may be configured as a primary RLC entity by the network entity 102, and the other may be configured as a secondary RLC entity by the network entity 102.

It shall be understood that the number of the MCG bearer, the SCG bearer and the split bearer is illustrated in FIG. 3 by way of example. The present disclosure may be applicable to any appropriate number of MCG bearers, SCG bearers and split bearers.

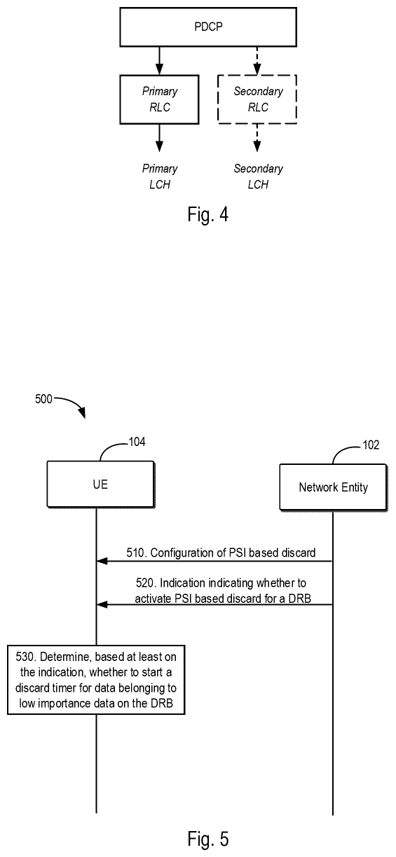

FIG. 4 illustrates an example of packet duplication in accordance with aspects of the present disclosure.

In some implementations, packet duplication is performed at PDCP. Thus, packet duplication may be referred to as PDCP duplication.

In some implementations, a radio bearer may be configured with packet duplication. A radio bearer configured with packet duplication is also referred to as duplication radio bearer. Similarly, a DRB configured with packet duplication is also referred to as duplication DRB.

When packet duplication is configured for a radio bearer (for example, by an RRC message), at least one secondary RLC entity is added to a radio bearer to handle the duplicated PDCP PDUs as depicted in FIG. 4.

As shown in FIG. 4, a logical channel corresponding to a primary RLC entity is referred to as a primary logical channel, and a logical channel corresponding to the secondary RLC entity(ies) is referred to as the secondary logical channel(s). All RLC entities have the same RLC mode. Duplication at PDCP therefore consists in submitting the same PDCP PDUs multiple times: once to each activated RLC entity for the radio bearer.

The logical channels of a radio bearer configured with duplication can either belong to the same MAC entity (referred to as CA duplication) or to different ones (referred to as DC duplication). CA duplication can also be configured in either or both of the MAC entities together with DC duplication when duplication over more than two RLC entities is configured for the radio bearer.

FIG. 5 illustrates a signaling diagram illustrating an example process 500 that supports PSI based discard in accordance with aspects of the present disclosure. The process 500 may involve the UE 104 and the network entity 102 in FIG. 1. For the purpose of discussion, the process 500 will be described with reference to FIG. 1.

As shown in FIG. 5, the network entity 102 transmits 510 a configuration of PSI based discard to the UE 104.

In some implementations, the network entity 102 may transmit a PDCP discard timer configuration for one DRB to the UE 104 in an RRC message. The PDCP discard timer configuration may comprise the configuration of PSI based discard.

In some implementations, the PDCP discard timer configuration may comprise a first PDCP discard timer and a second PDCP discard timer. The second PDCP discard timer is associated with the PSI based discard. Hereinafter, the second PDCP discard timer is also referred to as an additional PDCP discard timer, PSI-DiscardTimer or discardTimerForLowImportance.

In some implementations, a value of the additional PDCP discard timer may be equal to or shorter than that of the first PDCP discard timer.

In some implementations, the PDCP discard timer configuration may comprise psi-BasedDiscard status information element (IE), which indicates the PSI based discard is activated or deactivated. In other words, the psi-BasedDiscard status IE indicates a status of the PSI based discard. The status of the PSI based discard may be activation or deactivation.

In some implementations, a default status of the PSI based discard may be deactivation if the status of the PSI based discard is not indicated in the RRC message, e.g., upon receiving the configuration of PSI based discard or after handover.

Accordingly, the UE 104 receives the configuration of PSI based discard from the network entity 102.

In some implementations, when the first discard timer or second discard timer expires for a PDCP SDU, if PDU Set based discard is configured, the transmitting PDCP entity of the UE 104 shall discard all PDCP SDUs belonging to the PDU Set to which the PDCP SDU belongs along with the corresponding PDCP Data PDUs, else the transmitting PDCP entity of the UE 104 discards the PDCP SDU along with the corresponding PDCP Data PDU.

In addition, the UE 104 may configure the PDCP entity of the DRB based on the configuration of PSI based discard.

In turn, the network entity 102 transmits 520 an indication to the UE 104. The indication indicates whether to activate PSI based discard for a DRB. Hereinafter, for brevity, the indication indicating whether to activate PSI based discard for a DRB is also referred to as “PSI based discard activation/deactivation indication”. The PSI based discard activation/deactivation indication may be individually referred to as a PSI based discard activation indication and a PSI based discard deactivation indication.

In some implementations, the network entity 102 may transmit the PSI based discard activation/deactivation indication via a MAC control element (CE). Hereinafter, a MAC CE carrying the PSI based discard activation/deactivation indication is also referred to as “PSI based discard activation/deactivation MAC CE” or “PSI based SDU discard activation/deactivation MAC CE”. For example, a MAC CE carrying the PSI based discard activation indication is also referred to as “PSI based discard activation MAC CE” or “PSI based SDU discard activation MAC CE”, and a MAC CE carrying the PSI based discard deactivation indication is also referred to as “PSI based discard deactivation MAC CE” or “PSI based SDU discard deactivation MAC CE”.

In some implementations, when a first cell group (e.g., MCG or SCG) detects a UL congestion is high or not low, the first cell group determines to transmit a PSI based discard activation MAC CE to the UE 104.

Alternatively, in some implementations, when the first cell group (e.g., MCG or SCG) detects the UL congestion is not high or low, the first cell group determines to transmit a PSI based discard deactivation MAC CE to the UE 104.

In some implementations, a MAC sub-header associated with the PSI based discard activation/deactivation MAC CE may comprise an assigned logical channel identity (LCID) in a first field to identify the PSI based discard activation/deactivation MAC CE.

Upon receiving the PSI based discard activation/deactivation indication from the network entity 102, the UE 104 determines 530, based at least on the indication, whether to start the additional discard timer for data belonging to low importance data (e.g., with a PSI value) on the DRB.

In some implementations, upon receiving the PSI based discard activation/deactivation indication from the network entity 102, the UE 104 only starts one discard timer for data belonging to low importance data (e.g., with a PSI value) on the DRB, either a first PDCP discard timer or a second PDCP discard timer for data on the DRB.

In some implementations, the data with the PSI value may comprise data in at least one PDU Set with the PSI value.

In some implementations, the data belonging to low importance data may comprise data in at least one PDU Set belonging to low importance data.

In some implementations, the UE 104 may determine whether to start the additional discard timer for data on at least one DRB with at least one RLC entity associated with the MAC entity which receives the PSI based discard activation/deactivation indication from the network entity 102.

In some implementations, the UE 104 may receive the PSI based discard activation/deactivation indication via a first MAC entity of the UE 104. In such implementations, the UE 104 may determine whether to start the additional discard timer for the DRB if at least one RLC entity of the DRB is associated with the first MAC entity. In a first option, the at least one RLC entity of the DRB may comprise all RLC entities of the DRB. This will be described with reference to FIG. 3. In a second option, the at least one RLC entity of the DRB may comprise all RLC entities activated for PDCP duplication of the duplication DRB.

As shown in FIG. 3, in some implementations, the UE 104 may receive the PSI based discard activation/deactivation indication via the MN MAC entity 350 from MCG. In other words, the MN MAC entity 350 may receive the PSI based discard activation/deactivation indication from MCG. Because all RLC entities of the MCG DRB is associated with the MN MAC entity 350, the MN MAC entity 350 notifies information about the PSI based discard activation/deactivation indication to the NR PDCP entity 320 of the MCG DRB.

In some implementations, multiple MCG DRBs may be applied to the UE 104. PDCP entities and all RLC entities of the multiple MCG DRBs may be associated with the MN MAC entity 350. In such implementations, the MN MAC entity 350 notifies the information about the PSI based discard activation/deactivation indication to the PDCP entities of the multiple MCG DRBs.

Alternatively, in some implementations, the UE 104 may receive the PSI based discard activation/deactivation indication via the SN MAC entity 360 from SCG. In other words, the SN MAC entity 360 may receive the PSI based discard activation/deactivation indication from SCG. Because all RLC entities (i.e., the SN RLC entity 340) of the SCG DRB is associated with the SN MAC entity 360, the SN MAC entity 360 notifies information about the PSI based discard activation/deactivation indication to the NR PDCP entity 324 of the SCG DRB.

In some implementations, multiple SCG DRBs may be applied to the UE 104. PDCP entities and all RLC entities of the multiple SCG DRBs may be associated with the SN MAC entity 360. In such implementations, the SN MAC entity 360 notifies the information about the PSI based discard activation/deactivation indication to the PDCP entities of the multiple SCG DRBs.

In some implementations, the UE 104 may receive the PSI based discard activation/deactivation indication via a first MAC entity of the UE 104. In a second option, the UE 104 may determine whether to start the additional discard timer for the DRB if at least one RLC entity of the DRB is associated with the first MAC entity. This will be described with reference to FIG. 3.

As shown in FIG. 3, in some implementations, the UE 104 may receive the PSI based discard activation/deactivation indication via the MN MAC entity 350 from MCG. In other words, the MN MAC entity 350 may receive the PSI based discard activation/deactivation indication from MCG. Because all RLC entities (i.e., the MN RLC entity 330) of the MCG DRB and one RLC entity (i.e., the MN RLC entity 332) of the split DRB are associated with the MN MAC entity 350, the MN MAC entity 350 notifies information about the PSI based discard activation/deactivation indication to the NR PDCP entity 320 of the MCG DRB and to the NR PDCP entity 322 of the split DRB.

Alternatively, in some implementations, the UE 104 may receive the PSI based discard activation/deactivation indication via the SN MAC entity 360 from SCG. In other words, the SN MAC entity 360 may receive the PSI based discard activation/deactivation indication from SCG. Because all RLC entities (i.e., the SN RLC entity 340) of the SCG DRB and one RLC entity (i.e., the SN RLC entity 342) of the split DRB are associated with the SN MAC entity 360, the SN MAC entity 360 notifies information about the PSI based discard activation/deactivation indication to the NR PDCP entity 324 of the SCG DRB and to the NR PDCP entity 322 of the split DRB.

In some implementations, the UE 104 may receive the PSI based discard activation/deactivation indication via a first MAC entity of the UE 104. In such implementations, the UE 104 may determine whether to start the additional discard timer for the DRB if at least one RLC entity of the DRB is associated with the first MAC entity. In a third option, the at least one RLC entity of the DRB comprises a primary RLC entity of the DRB. For example, the DRB may comprises a split DRB and the at least one RLC entity of the DRB may comprises a primary RLC entity of the split DRB. For another example, the DRB may comprises a duplication DRB, and the at least one RLC entity of the DRB may comprises a primary RLC entity of the duplication DRB. This will be described with reference to FIG. 3. In a fourth option, the at least one RLC entity of the DRB comprises an RLC entity activated for PDCP duplication of the duplication DRB. For example, the DRB may comprise a duplication DRB and the at least one RLC entity of the DRB may comprise an RLC entity activated for PDCP duplication of the duplication DRB.

As shown in FIG. 3, in some implementations, the MN RLC entity 332 may be configured as a primary RLC entity of the split DRB. The UE 104 may receive the PSI based discard activation/deactivation indication via the MN MAC entity 350 from MCG. In other words, the MN MAC entity 350 may receive the PSI based discard activation/deactivation indication from MCG. Because the primary RLC entity (i.e., the MN RLC entity 332) of the split DRB is associated with the MN MAC entity 350, the MN MAC entity 350 notifies information about the PSI based discard activation/deactivation indication to the NR PDCP entity 322 of the split DRB.

Alternatively, in some implementations, the SN RLC entity 342 may be configured as a primary RLC entity of the split DRB. The UE 104 may receive the PSI based discard activation/deactivation indication via the SN MAC entity 360 from SCG. In other words, the SN MAC entity 360 may receive the PSI based discard activation/deactivation indication from SCG. Because the primary RLC entity (i.e., the SN RLC entity 342) of the split DRB is associated with the SN MAC entity 360, the SN MAC entity 360 notifies information about the PSI based discard activation/deactivation indication to the NR PDCP entity 322 of the split DRB.

In some implementations, PSI based discard can be referred to as PSI based SDU discard.

In some implementations, a PSI value of a PDU set is of low or lower importance, and identification of PSI of PDU Set and determination of low or lower importance PDU Set are left up to UE implementation.

In some implementations, at reception of a PDCP SDU from upper layers, if the PSI based discard is activated and the PDCP SDU belongs to low importance data (e.g., the PDCP SDU is associated with the PSI value), the transmitting PDCP entity of the UE 104 may start the additional discard timer associated with this PDCP SDU (if configured). If the PSI based discard is deactivated and/or the PDCP SDU does not belong to low importance data (e.g., the PDCP SDU is not associated with the PSI value), the transmitting PDCP entity of the UE 104 may start the first discard timer associated with this PDCP SDU (if configured).

Alternatively, in some implementations, at reception of a PDCP SDU from upper layers, if the PSI based discard is activated and the PDCP SDU belongs to a lower or low importance PDU Set (e.g., with the PSI value), the transmitting PDCP entity of the UE 104 may start the additional discard timer associated with this PDCP SDU (if configured). If the PSI based discard is deactivated and/or the PDCP SDU does not belong to the lower or low importance PDU Set (e.g., with the PSI value), the transmitting PDCP entity of the UE 104 may start the first discard timer associated with this PDCP SDU (if configured).

As described above, in some implementations, when the first cell group (e.g., MCG or SCG) detects the UL congestion is not high or low, the first cell group determines to transmit a PSI based discard deactivation MAC CE to the UE 104.

In some implementations, if the UE 104 receives the PSI based discard deactivation MAC CE from the network entity 102, the UE 104 starts the first discard timer associated with PDCP SDU belonging to all PDU set of the DRBs with RLC entities associated with the MAC entity receiving the MAC CE. i.e., the UE 104 resume or apply the first PDCP discard timer to the lower or low importance PDU sets.

In some implementation, the status of PSI based discard may be indicated per cell group by an RRC message or MAC CE. In some implementations, a default status of the PSI based discard may be deactivation if the status of the PSI based discard is not indicated in the RRC message, e.g., upon receiving the configuration of PSI based discard or after handover.

In such implementations, the PSI based discard activation/deactivation indication may indicate which cell group(s) to activate the additional discard timer for data on at least one DRB associated with the cell group(s). In such implementations, the UE 104 may determine whether to start the additional discard timer if the DRB is associated with one of the indicated at least one cell group.

In some implementation, the PSI based discard activation/deactivation MAC CE may comprise a bitmap, and each bit of the bit map corresponds to a cell group. For example, 1 bit corresponds to MCG and 1 bit corresponds to SCG. A bit value of 1 represents the PSI based discard is activated, and a bit value of 0 represents the PSI based discard is deactivated.

Alternatively, in some implementation, the PSI based discard activation/deactivation MAC CE may comprise at least one of the following fields:
which cell group(s)
For example, 1 bit length, value 0 identifies the MCG, value 1 identifies one or more SCG.
activation or deactivation status
For example, 1 bit length, value 1 indicates the activation status, value 0 indicates the deactivation status.

In some implementations, the PSI based discard activation/deactivation indication further indicates whether to activate the PSI based discard for at least one cell group. In some implementations, the UE 104 may determine whether to start the additional discard timer if at least one RLC entity of the DRB is associated with one of the at least one cell group. In a fourth option, the at least one RLC entity of the DRB may comprise all RLC entities of the DRB. This will be described with reference to FIG. 3.

As shown in FIG. 3, in some implementations, the MN MAC entity 350 may receive the PSI based discard activation/deactivation indication from MCG or the SN MAC entity 360 may receive the PSI based discard activation/deactivation indication from SCG.

For example, the PSI based discard activation/deactivation indication indicates whether to activate the PSI based discard for MCG. The MN MAC entity 350 or the SN MAC entity 360 notifies information about the PSI based discard activation/deactivation indication to the NR PDCP entity 320 of the MCG DRB associated with MCG.

In some implementations, multiple MCG DRBs may be applied to the UE 104. In such implementations, the MN MAC entity 350 or the SN MAC entity 360 notifies the information about the PSI based discard activation/deactivation indication to PDCP entities of the multiple MCG DRBs associated with MCG.

For example, the PSI based discard activation/deactivation indication indicates whether to activate the PSI based discard for SCG. The MN MAC entity 350 or the SN MAC entity 360 notifies information about the PSI based discard activation/deactivation indication to the NR PDCP entity 324 of the SCG DRB associated with SCG.

In some implementations, multiple SCG DRBs may be applied to the UE 104. In such implementations, the MN MAC entity 350 or the SN MAC entity 360 notifies the information about the PSI based discard activation/deactivation indication to PDCP entities of the multiple SCG DRBs associated with SCG.

In some implementations, the PSI based discard activation/deactivation indication further indicates whether to activate the PSI based discard for at least one cell group. In a fourth, the UE 104 may determine whether to start the additional discard timer if at least one RLC entity of the DRB is associated with one of the at least one cell group. This will be described with reference to FIG. 3.

As shown in FIG. 3, in some implementations, the MN MAC entity 350 may receive the PSI based discard activation/deactivation indication from MCG or the SN MAC entity 360 may receive the PSI based discard activation/deactivation indication from SCG.

For example, the PSI based discard activation/deactivation indication indicates whether to activate the PSI based discard for MCG. Because the MN RLC 330 of the MCG DRB and the MN RLC 332 of the split DRB are associated with MCG, the MN MAC entity 350 or the SN MAC entity 360 notifies information about the PSI based discard activation/deactivation indication to the NR PDCP entity 320 of the MCG DRB and to the NR PDCP entity 322 of the split DRB.

For another example, the PSI based discard activation/deactivation indication indicates whether to activate the PSI based discard for MCG. Because the MN RLC 330 of the MCG DRB and an RLC activated for PDCP duplication of a duplication DRB (which is not shown in FIG. 3) are associated with MCG, the MN MAC entity 350 or the SN MAC entity 360 notifies information about the PSI based discard activation/deactivation indication to the NR PDCP entity 320 of the MCG DRB and to a PDCP entity of the duplication DRB.

For a further example, the PSI based discard activation/deactivation indication indicates whether to activate the PSI based discard for SCG. Because the SN RLC 340 of the SCG DRB and the SN RLC 342 of the split DRB are associated with SCG, the SN MAC entity 350 or the SN MAC entity 360 notifies information about the PSI based discard activation/deactivation indication to the NR PDCP entity 324 of the SCG DRB and to the NR PDCP entity 322 of the split DRB.

For a yet further example, the PSI based discard activation/deactivation indication indicates whether to activate the PSI based discard for SCG. Because the SN RLC 340 of the SCG DRB and an RLC activated for PDCP duplication of a duplication DRB (which is not shown in FIG. 3) are associated with SCG, the SN MAC entity 350 or the SN MAC entity 360 notifies information about the PSI based discard activation/deactivation indication to the NR PDCP entity 324 of the SCG DRB and to the PDCP entity of the duplication DRB.

In some implementations, the PSI based discard activation/deactivation indication further indicates whether to activate the PSI based discard for at least one cell group. In some implementations, the UE 104 may determine whether to start the additional discard timer if at least one RLC entity of the DRB is associated with one of the at least one cell group. In a sixth option, the at least one RLC entity of the DRB comprises a primary RLC entity of the DRB. For example, the DRB may comprises a split DRB and the at least one RLC entity of the DRB may comprises a primary RLC entity of the split DRB. For another example, the DRB may comprises a duplication DRB, and the at least one RLC entity of the DRB may comprises a primary RLC entity of the duplication DRB. This will be described with reference to FIG. 3.

As shown in FIG. 3, the MN MAC entity 350 may receive the PSI based discard activation/deactivation indication from MCG or the SN MAC entity 360 may receive the PSI based discard activation/deactivation indication from SCG.

For example, the MN RLC entity 332 may be configured as a primary RLC entity of the split DRB, and the MN RLC entity 332 is associated with MCG. The PSI based discard activation/deactivation indication indicates whether to activate the PSI based discard for MCG. Because the MN RLC entity 332 configured as the primary RLC entity of the split DRB is associated with MCG, the MN MAC entity 350 or the SN MAC entity 360 notifies information about the PSI based discard activation/deactivation indication to the NR PDCP entity 322 of the split DRB.

For another example, the SN RLC entity 342 may be configured as a primary RLC entity of the split DRB, and the SN RLC entity 342 is associated with SCG. The PSI based discard activation/deactivation indication indicates whether to activate the PSI based discard for SCG. Because the SN RLC entity 342 configured as the primary RLC entity of the split DRB is associated with SCG, the MN MAC entity 350 or the SN MAC entity 360 notifies information about the PSI based discard activation/deactivation indication to the NR PDCP entity 322 of the split DRB.

In some implementations, the UE 104 may determine whether to start the additional discard timer based on determining the following: the primary RLC entity of the DRB is associated with one of the at least one cell group, and data volume of data to be transmitted on the DRB is less than a split threshold. In some implementations, the data volume of data is the total amount of PDCP data volume and RLC data volume pending for initial transmission (as specified in TS 38.322) in the primary RLC entity and the split secondary RLC entity of the DRB.

In some implementation, the status of PSI based discard may be indicated per bearer type by an RRC message or MAC CE. In some implementations, a default status of the PSI based discard may be deactivation if the status of the PSI based discard is not indicated in the RRC message.

In such implementations, the PSI based discard activation/deactivation indication may indicate which bearer type(s) to activate the additional discard timer for data on at least one DRB with the bearer type(s). In such implementations, the UE 104 may determine whether to start the additional discard timer if the DRB is of one of the indicated at least one bearer type. In other words, the UE 104 may determine whether to start the additional discard timer if the DRB has one of the at least one indicated bearer type.

In some implementation, the PSI based discard activation/deactivation MAC CE may comprise at least one of the following fields:
which bearer type(s)
For example, the at least one bearer type comprises at least one of MCG DRB, SCG DRB, or split DRB
activation or deactivation status
For example, 1 bit length, value 1 indicates the activation status, value 0 indicates the deactivation status.

In some implementations, the PSI based discard activation/deactivation indication further indicates whether to activate the PSI based discard for at least one cell group. In such implementations, the UE 104 may determine whether to start the additional discard timer if at least one RLC entity of the DRB is associated with one of the at least one cell group and PDCP duplication is activated for the at least one RLC entity of the DRB.

For example, in the option 2 or option 4 as described above, the UE 104 may determine whether to start the additional discard timer if at least one RLC entity of the DRB is associated with one of the at least one cell group and PDCP duplication is activated for the at least one RLC entity of the DRB.

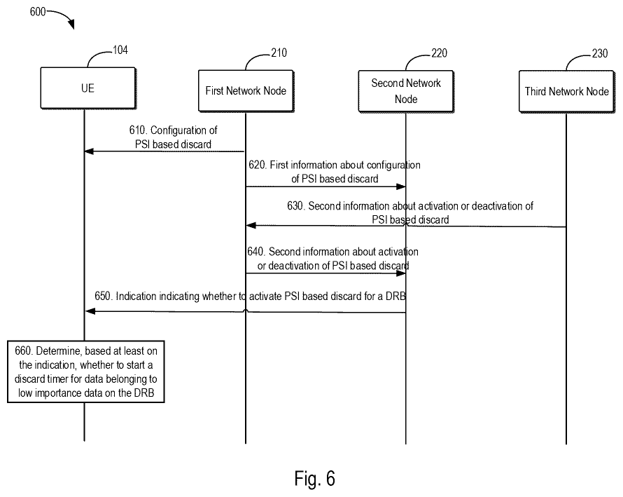

In some implementations, in case of DC, for a split DRB, the node hosting NR PDCP entity may determine the DL congestion status of both the node hosting PDCP entity and the corresponding node according to the DL Data delivery status from the corresponding node. Therefore, it had better to transmit the PSI based discard activation indication to the UE 104 by the node without DL congestion being detected. In such implementations, the node hosting NR PDCP entity may coordinate with the corresponding node for information about the PSI based discard activation/deactivation indication. This will be described with reference to FIG. 6.

FIG. 6 illustrates a signaling diagram illustrating an example process 600 that supports PSI based discard in accordance with aspects of the present disclosure. The process 600 may be considered as an example implementation of the process 500. The process 600 may involve the UE 104, the first network node 210, the second network node 220 and the third network node 230 in FIG. 2. For the purpose of discussion, the process 600 will be described with reference to FIG. 2.

As shown in FIG. 6, the first network node 210 transmits 610 a configuration of PSI based discard to the UE 104. The action 610 is similar to the action 510 in the process 500. Thus, details of this action is omitted for brevity.

The first network node 210 transmits 620 first information about the configuration of PSI based discard to the second network node 220.

It shall be understood that the action 610 is shown prior to the action 620 in FIG. 6 by way of example. In other implementations, the action 610 may be performed in parallel to or subsequent to the action 620.

In some implementations, the first network node 210 may transmit the first information about the configuration of PSI based discard via F1AP message (e.g., UE CONTEXT SETUP REQUEST message, or UE CONTEXT MODIFICATION REQUEST message).

In some implementations, the first information about the configuration of PSI based discard may indicate the additional discard timer is configured for the UE 104.

In some implementations, the first information about the configuration of PSI based discard may indicate the additional discard timer is configured for which DRB.

In some implementations, the first information about the configuration of PSI based discard may indicate the PSI based discard is configured for the UE 104.

In some implementations, the first information about the configuration of PSI based discard may indicate the PSI based discard is configured for which DRB.

The first network node 210 receives 630, from the third network node 230, second information about activation or deactivation of the PSI based discard, e.g., for which UE.

In some implementations, the first network node 210 may receive the second information about activation or deactivation of the PSI based discard via a DL DATA DELIVER STATUS frame or an ASSISTANCE INFORMATION DATA frame.

In some implementations, the second information about activation or deactivation of the PSI based discard may comprise contents in the PSI based discard activation/deactivation MAC CE. For example, the second information about activation or deactivation of the PSI based discard may comprise contents in fields of the PSI based discard activation/deactivation MAC CE.

In some implementations, the PSI based discard activation/deactivation indication further indicates whether to activate the PSI based discard for at least one cell group. Alternatively, the PSI based discard activation/deactivation indication further indicates whether to activate the PSI based discard for at least one bearer type.

In some implementations, the second information about activation or deactivation of the PSI based discard may comprise a request for transmitting the PSI based discard activation/deactivation indication to the UE 104. In other words, the second information may request, indicate or suggest to transmit the PSI based discard activation/deactivation indication to the UE 104.

In some implementations, the second information about activation or deactivation of the PSI based discard may comprise an uplink congestion status in the third network node 230.

In turn, the first network node 210 transmits 640, to the second network node 220, the second information about activation or deactivation of the PSI based discard.

Then, the second network node 220 transmits 650 the PSI based discard activation/deactivation indication to the UE 104. The action 650 is similar to the action 520 in the process 500. Thus, details of this action is omitted for brevity.

Upon receiving the PSI based discard activation/deactivation indication from the network entity 102, the UE 104 determines 660, based at least on the indication, whether to start the additional discard timer for data belonging to low importance data (e.g., with a PSI value) on the DRB. The action 660 is similar to the action 530 in the process 500. Thus, details of this action is omitted for brevity.

It shall be noted that the implementations as described with reference to FIGS. 1 to 5 are also applicable to the process 600. Details of the implementations are omitted for brevity.

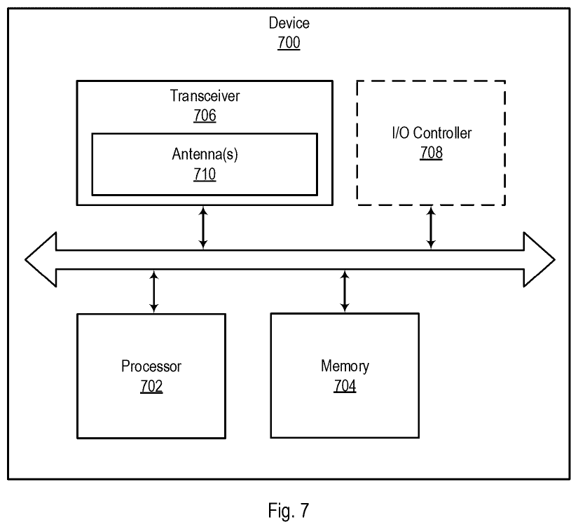

FIG. 7 illustrates an example of a device 700 that supports PSI based discard in accordance with aspects of the present disclosure. The device 700 may be an example of a network entity 102 or a UE 104 as described herein. The device 700 may support wireless communication with one or more network entities 102, UEs 104, or any combination thereof. The device 700 may include components for bi-directional communications including components for transmitting and receiving communications, such as a processor 702, a memory 704, a transceiver 706, and, optionally, an I/O controller 708. These components may be in electronic communication or otherwise coupled (e.g., operatively, communicatively, functionally, electronically, electrically) via one or more interfaces (e.g., buses).

The processor 702, the memory 704, the transceiver 706, or various combinations thereof or various components thereof may be examples of means for performing various aspects of the present disclosure as described herein. For example, the processor 702, the memory 704, the transceiver 706, or various combinations or components thereof may support a method for performing one or more of the operations described herein.

In some implementations, the processor 702, the memory 704, the transceiver 706, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 702 and the memory 704 coupled with the processor 702 may be configured to perform one or more of the functions described herein (e.g., executing, by the processor 702, instructions stored in the memory 704).

For example, the processor 702 may support wireless communication at the device 700 in accordance with examples as disclosed herein. The processor 702 may be configured to operable to support a means for performing the following: receiving an indication from a network entity, the indication indicating whether to activate PSI based discard for a DRB; and determining whether to start, based at least on the indication, a discard timer for data belonging to low importance data (e.g., with a PSI value) on the DRB, the discard timer being associated with the PSI based discard.

Alternatively, in some implementations, the processor 702 may be configured to operable to support a means for performing the following: transmitting, to a second network node, first information about a configuration of PSI based discard for a DRB; and transmitting the configuration of PSI based discard to a UE.

Alternatively, in some implementations, the processor 702 may be configured to operable to support a means for performing the following: receiving, from a first network node, first information about a configuration of PSI based discard for a DRB; and transmitting, to a UE, an indication indicating whether to activate the PSI based discard.

The processor 702 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 702 may be configured to operate a memory array using a memory controller. In some other implementations, a memory controller may be integrated into the processor 702. The processor 702 may be configured to execute computer-readable instructions stored in a memory (e.g., the memory 704) to cause the device 700 to perform various functions of the present disclosure.

The memory 704 may include random access memory (RAM) and read-only memory (ROM). The memory 704 may store computer-readable, computer-executable code including instructions that, when executed by the processor 702 cause the device 700 to perform various functions described herein. The code may be stored in a non-transitory computer-readable medium such as system memory or another type of memory. In some implementations, the code may not be directly executable by the processor 702 but may cause a computer (e.g., when compiled and executed) to perform functions described herein. In some implementations, the memory 704 may include, among other things, a basic I/O system (BIOS) which may control basic hardware or software operation such as the interaction with peripheral components or devices.

The I/O controller 708 may manage input and output signals for the device 700. The I/O controller 708 may also manage peripherals not integrated into the device M02. In some implementations, the I/O controller 708 may represent a physical connection or port to an external peripheral. In some implementations, the I/O controller 708 may utilize an operating system such as iOS®, ANDROID®, MS-WINDOWS®, OS/2®, UNIX®, LINUX®, or another known operating system. In some implementations, the I/O controller 708 may be implemented as part of a processor, such as the processor 706. In some implementations, a user may interact with the device 700 via the I/O controller 708 or via hardware components controlled by the I/O controller 708.

In some implementations, the device 700 may include a single antenna 710. However, in some other implementations, the device 700 may have more than one antenna 710 (i.e., multiple antennas), including multiple antenna panels or antenna arrays, which may be capable of concurrently transmitting or receiving multiple wireless transmissions. The transceiver 706 may communicate bi-directionally, via the one or more antennas 710, wired, or wireless links as described herein. For example, the transceiver 706 may represent a wireless transceiver and may communicate bi-directionally with another wireless transceiver. The transceiver 706 may also include a modem to modulate the packets, to provide the modulated packets to one or more antennas 710 for transmission, and to demodulate packets received from the one or more antennas 710. The transceiver 706 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 710 for transmitting the amplified signal into the air or wireless medium.

A receive chain may be configured to receive signals (e.g., control information, data, packets) over a wireless medium. For example, the receive chain may include one or more antennas 710 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

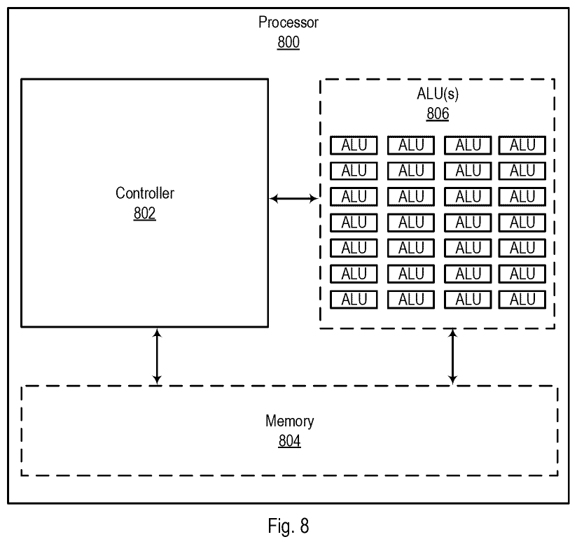

FIG. 8 illustrates an example of a processor 800 that supports PSI based discard in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, such as L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementation, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementation, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to operable to support a means for performing the following: receiving an indication from a network entity, the indication indicating whether to activate PSI based discard for a DRB; and determining, based at least on the indication, whether to start a discard timer for data belonging to low importance data (e.g., with a PSI value) on the DRB, the discard timer being associated with the PSI based discard.

Alternatively, in some implementations, the processor 800 may be configured to operable to support a means for performing the following: transmitting, to a second network node, first information about a configuration of PSI based discard for a DRB; and transmitting the configuration of PSI based discard to a UE.

Alternatively, in some implementations, the processor 800 may be configured to operable to support a means for performing the following: receiving, from a first network node, first information about a configuration of PSI based discard for a DRB; and transmitting, to a UE, an indication indicating whether to activate the PSI based discard.

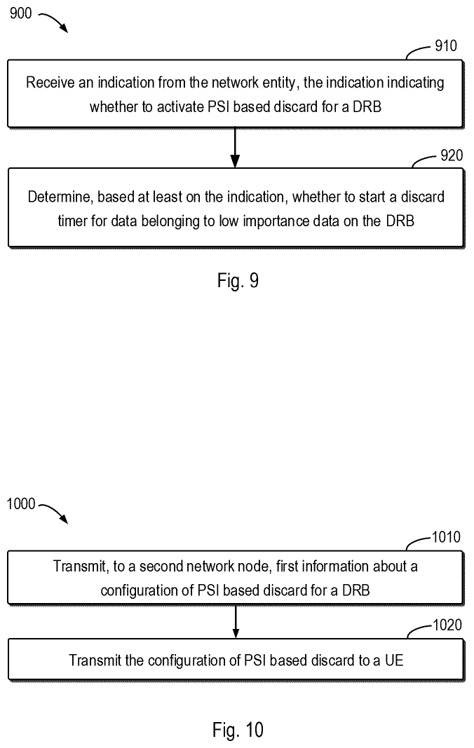

FIG. 9 illustrates a flowchart of a method 900 that supports PSI based discard in accordance with aspects of the present disclosure. The operations of the method 900 may be implemented by a device or its components as described herein. For example, the operations of the method 900 may be performed by a UE 104 as described herein. In some implementations, the device may execute a set of instructions to control the function elements of the device to perform the described functions. Additionally, or alternatively, the device may perform aspects of the described functions using special-purpose hardware.

At 910, the method may include receiving an indication from a network entity. The indication indicates whether to activate PSI based discard for a DRB. The operations of 910 may be performed in accordance with examples as described herein. In some implementations, aspects of the operations of 910 may be performed by a device as described with reference to FIG. 1 or 2.

At 920, the method may include determining, based at least on the indication, whether to start a discard timer for data belonging to low importance data (e.g., with a PSI value) on the DRB, the discard timer being associated with the PSI based discard. The operations of 920 may be performed in accordance with examples as described herein. In some implementations, aspects of the operations of 920 may be performed by a device as described with reference to FIG. 1 or 2.

FIG. 10 illustrates a flowchart of a method 1000 that supports PSI based discard in accordance with aspects of the present disclosure. The operations of the method 1000 may be implemented by a device or its components as described herein. For example, the operations of the method 1000 may be performed by the network node 210 as described herein. In some implementations, the device may execute a set of instructions to control the function elements of the device to perform the described functions. Additionally, or alternatively, the device may perform aspects of the described functions using special-purpose hardware.

At 1010, the method may include transmitting, to a second network node, first information about a configuration of PSI based discard for a DRB. The operations of 1010 may be performed in accordance with examples as described herein. In some implementations, aspects of the operations of 1010 may be performed by a device as described with reference to FIG. 2.

At 1020, the method may include transmitting the configuration of PSI based discard to a UE. The operations of 1020 may be performed in accordance with examples as described herein. In some implementations, aspects of the operations of 1020 may be performed by a device as described with reference to FIG. 2.

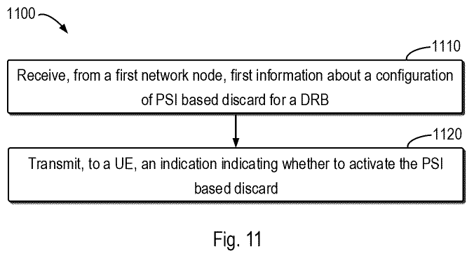

FIG. 11 illustrates a flowchart of a method 1100 that supports PSI based discard in accordance with aspects of the present disclosure. The operations of the method 1100 may be implemented by a device or its components as described herein. For example, the operations of the method 1100 may be performed by the network node 220 as described herein. In some implementations, the device may execute a set of instructions to control the function elements of the device to perform the described functions. Additionally, or alternatively, the device may perform aspects of the described functions using special-purpose hardware.

At 1110, the method may include receiving, from a first network node, first information about a configuration of PSI based discard for a DRB. The operations of 1110 may be performed in accordance with examples as described herein. In some implementations, aspects of the operations of 1110 may be performed by a device as described with reference to FIG. 2.

At 1120, the method may include transmitting, to a UE, an indication indicating whether to activate the PSI based discard. The operations of 1110 may be performed in accordance with examples as described herein. In some implementations, aspects of the operations of 1110 may be performed by a device as described with reference to FIG. 2.

It shall be noted that implementations of the present disclosure which have been described with reference to FIGS. 1 to 6 are also applicable to the device 700, the processor 800 and the methods 900, 1000 and 1100.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive an indication, from a network entity, indicating whether to activate Protocol Data Unit Set Importance (PSI) based discard for a Data Radio Bearer (DRB); and
determine, based at least on the indication, whether to start a discard timer for data belonging to low importance data on the DRB, wherein the discard timer is associated with the PSI based discard.

2. The UE of claim 1, wherein the at least one processor is configured to cause the UR to receive the indication via a first Medium Access Control (MAC) entity of the UE.

3. The UE of claim 2, wherein the at least one processor is configured to cause the UE to determine whether to start the discard timer based on determining that at least one Radio Link Control (RLC) entity of the DRB is associated with the first MAC entity.

4. The UE of claim 3, wherein the at least one RLC entity of the DRB comprises all RLC entities of the DRB; or the at least one RLC entity of the DRB comprises a primary RLC entity of the DRB.

5. The UE of claim 3, wherein the at least one processor is configured to cause the UE to determine whether to start the discard timer based on determining that packet data convergence protocol (PDCP) duplication is activated for the DRB.

6. The UE of claim 5, wherein the PDCP duplication is activated for the DRB; and
wherein: the at least one RLC entity of the DRB comprises all activated duplication RLC entities and the primary RLC entity of the DRB;
the at least one RLC entity of the DRB comprises an activated duplication RLC entity of the DRB; or
the at least one RLC entity of the DRB comprises a primary RLC entity of a duplication DRB.

7. The UE of claim 1, wherein the indication further indicates whether to activate the PSI based discard for at least one cell group; and
wherein the at least one processor is configured to cause the UE to determine whether to start the discard timer based on determining that the DRB is associated with a cell group of the at least one cell group.

8. The UE of claim 1, wherein the indication further indicates whether to activate the PSI based discard for at least one cell group; and
wherein the at least one processor is configured to cause the UE to determine whether to start the discard timer based on determining that at least one Radio Link Control (RLC) entity of the DRB is associated with cell group of the at least one cell group.

9. The UE of claim 7, wherein the at least one RLC entity of the DRB comprises all RLC entities of the DRB.

10. The UE of claim 7, wherein the at least one RLC entity of the DRB comprises a primary RLC entity of the DRB.

11. The UE of claim 1, wherein the indication further indicates whether to activate the PSI based discard for at least one bearer type; and
wherein the at least one processor is configured to cause the UE to determine whether to start the discard timer based on determining that the DRB is a bearer type of the at least one bearer type.

12. A first network node for wireless communication, comprising:
at least one memory; and
at least one processor coupled with the at least one memory and configured to cause the first network node to:
transmit, to a second network node, first information associated with a configuration of Protocol Data Unit Set Importance (PSI) based discard for a Data Radio Bearer (DRB); and
transmit the configuration of PSI based discard to a user equipment (UE).

13. The first network node of claim 12, wherein the at least processor is further configured to cause the first network node to:
receive, from a third network node, second information about activation or deactivation of the PSI based discard; and
transmit, to the second network node, the second information about activation or deactivation of the PSI based discard.

14. The first network node of claim 13, wherein the second information about activation or deactivation of the PSI based discard comprises:
contents in a Medium Access Control (MAC) Control Element (CE) carrying an indication indicating whether to activate the PSI based discard,
a request for transmitting the indication indicating whether to activate the PSI based discard to the UE, or
an uplink congestion status in the third network node.

15. The first network node of claim 14, wherein the indication further indicates whether to activate the PSI based discard for at least one cell group; or
wherein the indication further indicates whether to activate the PSI based discard for at least one bearer type.

16. A second network node for wireless communication, comprising:
at least one memory; and
at least one processor coupled with the at least one memory and configured to cause the second network node to:
receive, from a first network node, first information about a configuration of Protocol Data Unit Set Importance (PSI) based discard for a Data Radio Bearer (DRB); and
transmit, to a user equipment (UE), an indication indicating whether to activate the PSI based discard.

17. The second network node of claim 16, wherein the at least one processor is further configured to cause the second network node to:
receive, from the first network node, second information about activation or deactivation of the PSI based discard; and
transmit the indication based on the second information.

18. The second network node of claim 17, wherein the second information about activation or deactivation of the PSI based discard comprises:
contents in a Medium Access Control (MAC) Control Element (CE) carrying an indication indicating whether to activate the PSI based discard,
a request for transmitting the indication indicating whether to activate the PSI based discard from the first network node to the UE, or
an uplink congestion status in the second network node.

19. The second network node of claim 16, wherein the indication further indicates whether to activate the PSI based discard for at least one cell group; or
wherein the indication further indicates whether to activate the PSI based discard for at least one bearer type.

20. A processor for wireless communication, comprising:
a controller coupled with at least one memory and configured to cause the controller to:
receive an indication, from a network entity, whether to activate Protocol Data Unit Set Importance (PSI) based discard for a Data Radio Bearer (DRB); and
determine, based at least on the indication, whether to start a discard timer for data belonging to low importance data on the DRB, wherein the discard timer is associated with the PSI based discard.
